(19) United States
(12) Patent Application Publication
(10) Pub. No.: US 2009/0310001 A1
(43) Pub. Date: Dec. 17, 2009

(54) SOLID-STATE IMAGING DEVICE, DRIVING METHOD THEREOF, AND CAMERA

(75) Inventors: Masayuki MASUYAMA, Kyoto (JP); Masanori KYOGOKU, Osaka (JP)

Correspondence Address: GREENBLUM & BERNSTEIN, P.L.C., 1950 ROLAND CLARKE PLACE, RESTON, VA, 20191, US

(73) Assignee: Panasonic Corporation, Osaka (JP)

(21) Appl. No.: 12/475,758

(22) Filed: Jun. 1, 2009

(30) Foreign Application Priority Data
Jun. 17, 2008 (JP) 2008-157386

(51) Int. Cl. H04N 5/00

(52) U.S. Cl. 348/300

(57) ABSTRACT

A solid-state imaging device which optimizes gains for each color without a need for complicated control of changing the resistance values of variable resistances and switching switches depending on pixels from which signals are to be read, while preventing an S/N deterioration in AD conversion. The solid-state imaging device comprises: a plurality of pixels arranged in a matrix; column amplifiers, each amplifying signals generated by pixels of a corresponding one of columns of the matrix; and column AD converters, each performing AD conversion on a signal generated by a corresponding one of the column amplifiers, wherein each of the plurality of pixels corresponds to a color among colors, and each of the column amplifiers amplifies output signals generated by all pixels of a corresponding one of the colors, among pixels of the corresponding column of the matrix.

### BACKGROUND OF THE INVENTION

(1) Field of the Invention

The present invention relates to a solid-state imaging device that converts light into electric signals, and relates particularly to a solid-state imaging device provided with an amplifier and an AD converter for each column of pixels arranged in a matrix.

(2) Description of the Related Art

Color solid-state imaging devices (color image sensors) require white balance to adapt to changes in the color temperature and so on of the object. For example, the colors of the object vary depending on types of light (sunlight and fluorescent light, for example), and thus, to suit the color temperature in each scene, solid-state imaging devices need processing that makes white color of the object appear white even in image signals.

Conventionally, the following has been performed for the purpose of white balance: the number of bits (resolution) of the AD converters is increased so that 1 to 2 bits are used for a digital gain for white balance adjustment; pixel signals are amplified using analog gains that differ depending on the color (for example, see Patent Reference 1: Japanese Unexamined Patent Application Publication No. 2005-318292); and gains of column AD converters are adjusted for each color by varying the slope of the ramp waveform of a signal serving as a reference voltage in the column AD converters (for example, see Patent Reference 2: Japanese Unexamined Patent Application Publication No. 2005-328135).

FIG. 14 is a circuit block diagram of the conventional solid-state imaging device disclosed in Patent Reference 1. This solid-state imaging device includes: a plurality of pixels D11 to D44 that detect, for each color depending on the pixels, light entered to a photoelectric conversion element and generate sensor signals from photocurrents corresponding to each color; variable resistances VR1 to VR4 provided on the output side of the pixels and connected to a bias supply; switches SW1 to SW4 for selecting, from among the plurality of pixels, pixels from which the sensor signals are to be read; and a control unit that changes the resistance values of the variable resistances and the reading load depending on the colors of the pixels from which signals are to be read. With such a structure, the solid-state imaging device separately adjusts gains for each color of the pixels.

### SUMMARY OF THE INVENTION

However, the conventional approach of increasing the number of bits of the AD converters for the purpose of white balance entails a problem that a time required for counting clocks increases in the case where AD conversion is performed by using a ramp waveform for the reference signal and by counting clocks from when the reference signal starts to be varied until a comparator of the corresponding column shows a match between a pixel signal and the reference signal, as disclosed in Patent Reference 2. For example, an increase of 1 bit requires a double length of time for the AD conversion, thereby preventing an increase in the frame rate. In addition, although one may propose parallel processing using a plurality of comparator circuits as above and the like to increase the number of bits, such a structure results in an increase in the circuit size, causing a problem of an increased chip area and of increased power consumption, for example. One may also propose to increase the frequency of the clock for the conversion in order to increase the number of bits of the AD converters. Nonetheless, there are problems such as the clock rate is already at its limit and the power consumption increases due to high-speed driving.

In addition, the technique of Patent Reference 1 requires complicated control of suitably changing the resistance values of variable resistances VR1 to VR4 and switching the switches SW1 to SW4 depending on the color of the pixels from which signals are to be read.

Moreover, although Patent Reference 2 discloses the technique of adjusting the gains for each color by varying the slope of the ramp waveform, there is a problem that errors in the AD conversion increase and the S/N ratio deteriorates when a larger gain is required. This is because when a larger gain is required, the slope of the ramp waveform becomes significantly small, thereby making smaller the weighted voltage that serves as a 1-bit comparison voltage used for a comparison between a pixel signal and the reference signal.

The present invention has been conceived in view of such problems, and an object of the present invention is to provide a solid-state imaging device and the like which optimizes the gains for each color without the need for complicated control of changing the resistance values of variable resistances and switching the switches depending on the pixels from which signals are to be read, while preventing an S/N deterioration in the AD conversion.

In order to achieve the above object, the solid-state imaging device according to the present invention is a solid-state imaging device comprising: a plurality of pixels arranged in a matrix; column amplifiers, each amplifying signals generated by pixels of a corresponding one of columns of the matrix; and column AD converters, each performing AD conversion on a signal generated by a corresponding one of the column amplifiers, wherein each of the plurality of pixels generates a signal corresponding to intensity of incident light of a color among colors, and each of the column amplifiers amplifies output signals generated by all pixels of a corresponding one of the colors, among pixels of the corresponding column of the matrix. As a result, since the column amplifiers are provided for each color independently, it is possible to prevent a rate reduction and an S/N deterioration caused when white balance adjustment is performed only by the AD converters, and there is no longer a need for complicated control of changing the resistance values of variable resistances and switching the switches depending on the pixels from which signals are to be read.

Here, it is preferable that the plurality of pixels is arranged such that pixels corresponding to at least two colors are included in at least one column, the column amplifiers are arranged such that at least two column amplifiers correspond to each column of the matrix, one of the at least two column amplifiers amplifies output signals generated by pixels corresponding to a first color, among the pixels of the corresponding column which correspond to the at least two colors, and another one of the at least two column amplifiers amplifies output signals generated by pixels corresponding to a second color, among the pixels of the corresponding column which correspond to the at least two colors, the second color being different from the first color. As a result, with a color filter and the like of the Bayer arrangement, pixels in each column correspond to two colors, and thus a preferable structure of the color filter and the like of the Bayer arrangement can be achieved by providing column amplifiers on an area upper than the imaging surface and on an area lower than the imaging surface.

It should be noted that with regard to the arrangement of column signal lines, it may be that output signals generated by pixels of a column of the matrix are transferred to input terminals of the at least two column amplifiers corresponding to the column, via a corresponding one of at least two column signal lines corresponding to at least one column, among pixels of a column of the matrix which correspond to the at least two colors, pixels corresponding to a first color output signals to a corresponding one of the at least two column amplifiers via first one of the at least two column signal lines, and among the pixels of the column of the matrix which correspond to the at least two colors, pixels corresponding to a second color output signals to a corresponding one of the at least two column amplifiers via second one of the at least two column signal lines. Otherwise, it may be that output signals generated by pixels of a column of the matrix are transferred to input terminals of the at least two column amplifiers corresponding to the column, via a common column signal line, among pixels of a column of the matrix which correspond to the at least two colors, pixels corresponding to a first color output signals to a corresponding one of the at least two column amplifiers via the common column signal line, and pixels corresponding to a second color output signals to a corresponding one of the at least two column amplifiers via the common column signal line, by time division.

With regard to the planar arrangement, it is preferable that the solid-state imaging device is formed on a semiconductor substrate, and the column amplifiers are arranged on different areas that sandwich an area on which the plurality of pixels is formed, the areas being on a surface of the semiconductor substrate, on which a circuit is formed.

Further, it is desirable that each of the column amplifiers selects a gain from a plurality of gains based on an instruction from outside, and amplifies the signals using the selected gain. For example, it is desirable that the solid-state imaging device further comprises control lines, each for instructing a common gain to corresponding ones of the column amplifiers, the corresponding ones of the column amplifiers corresponding to a same color among the colors. As a result, it is possible to set a gain independent for each column amplifier corresponding to one of the colors, so as to perform the white balance adjustment.

Furthermore, it may be that the solid-state imaging device further comprises a reference signal generating unit configured to generate a reference signal having a ramp waveform that temporally makes monotonic variations, wherein each of the column AD converters includes: a comparator corresponding to a column of the matrix for comparing each of pixel signals generated by pixels of the corresponding column with the reference signal generated by the reference signal generating unit; and a counter unit configured to count clocks applied from when the reference signal generating unit starts varying the reference signal to when the comparator of the corresponding column shows a match between a pixel signal and the reference signal, wherein the reference signal generating unit is configured to vary a slope of the ramp waveform of the reference signal to be generated, based on an instruction from outside. Here, it is preferable that the solid-state imaging device comprises reference signal generating units, each configured to generate a reference signal having a ramp waveform which corresponds to one of the colors, wherein the comparator compares the reference signal with a pixel signal corresponding to the one of the colors, and the solid-state imaging device further comprises a control unit configured to instruct a slope of the ramp waveform to each of the reference signal generating units. As a result, white balance adjustment with higher precision is possible by adjusting not only the gains of the column amplifiers but also the gains for the AD conversion.

Here, it is preferable that the control unit is configured to control coarse adjustment for amplifying output signals generated by the plurality of pixels, by instructing a gain to the column amplifiers, and to control fine adjustment for amplifying the output signals generated by the plurality of pixels, by instructing a slope of the ramp waveform to the reference signal generating units. As a result, finer white balance adjustment is performed through coordination of the coarse adjustment and the fine adjustment, and it is possible, through the two adjustments being complementary to each other, to prevent image distortions caused by gain changes.

It is to be noted that the present invention can be embodied not only as a solid-state imaging device, but also as a camera equipped with the solid-state imaging device and a method for driving the solid-state imaging device.

According to the solid-state imaging device of the present invention, it is possible to optimize the gains for each color without the need for complicated control of changing the resistance values of variable resistances and switching the switches depending on the pixels from which signals are to be read, while preventing an S/N deterioration in the AD conversion.

Thus, the practical value of the present invention is very high today since there is a widespread use of digital cameras and mobile phones with built-in cameras that are demanded to perform appropriate white balance adjustment suited to the color temperature of the object while preventing a decrease in the processing rate and a deterioration in the S/N ratio, and are demanded to have higher resolution, a higher S/N ratio, lower power consumption, and high-speed capturing.

### FURTHER INFORMATION ABOUT TECHNICAL BACKGROUND TO THIS APPLICATION

The disclosure of Japanese Patent Application No. 2008-157386 filed on Jun. 17, 2008 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a circuit block diagram of a solid-state imaging device according to Embodiment 1 of the present invention;

FIG. 2 is a detailed circuit diagram of pixels;

FIG. 3 is a detailed circuit diagram of a set of a column amplifier and a column AD converter shown in FIG. 1;

FIG. 4A is a detailed circuit block diagram of a column amplifier;

FIG. 4B is a detailed circuit block diagram of a column amplifier in the case where an amplifier shown in FIG. 4A includes transistors;

FIG. 5A is a circuit block diagram showing a structure of a control unit included in a solid-state imaging device according to Embodiment 1;

FIG. 5B is a diagram showing block division of an imaging surface;

FIG. 6 is an explanatory diagram of an operation of a solid-state imaging device according to Embodiment 1 of the present invention;

FIG. 7 is a flowchart showing a procedure of controlling a gain adjustment for white balance, performed by a control unit;

FIG. 8 is a graph showing an illustration of gain setting for white balance suitable for color temperatures;

FIG. 9 is a circuit block diagram of a solid-state imaging device according to a variation of Embodiment 1;

FIG. 10 is a circuit block diagram of a solid-state imaging device according to Embodiment 2 of the present invention;

FIG. 11 is a circuit block diagram of a solid-state imaging device according to a variation of Embodiment 2;

FIG. 12 is a functional block diagram of a camera equipped with a solid-state imaging device of the present invention;

FIG. 13A is an external view of a camera as an example of the camera of FIG. 12;

FIG. 13B is an external view of a video camera as an example of the camera of FIG. 12; and

FIG. 14 is a circuit block diagram of a conventional solid-state imaging device.

### DESCRIPTION OF THE PREFERRED EMBODIMENT(S)

Hereinafter, embodiments of the solid-state imaging device according to the present invention shall be described in detail with reference to the drawings.

### Embodiment 1

First, Embodiment 1 of the present invention shall be described.

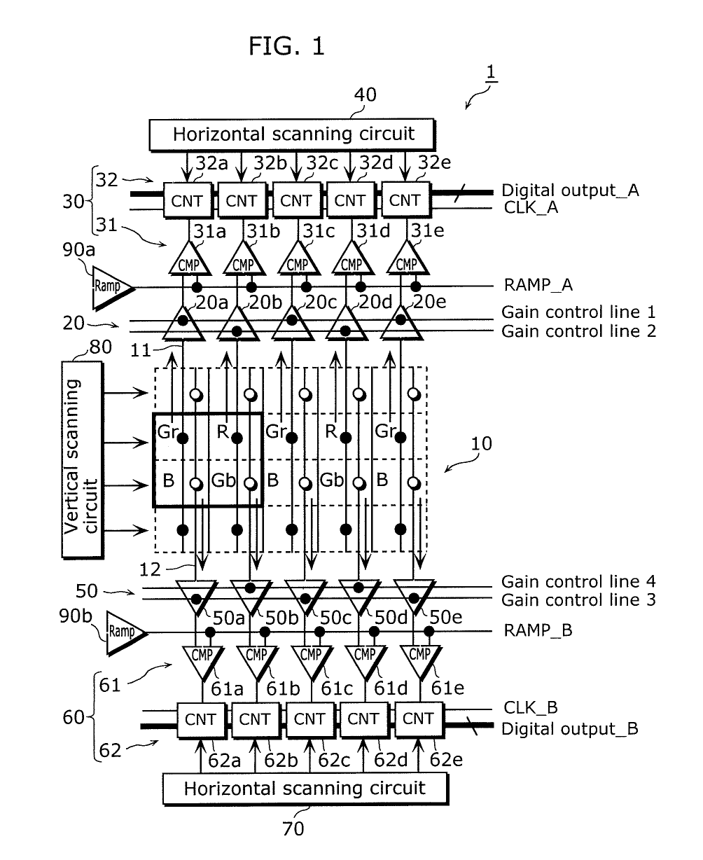

FIG. 1 is a circuit block diagram of a solid-state imaging device 1 according to Embodiment 1 of the present invention. The solid-state imaging device 1 is a color image sensor including pixels 10 that are formed on a semiconductor substrate and convert light into electric signals. It is characterized in including: column amplifiers 20 (20a to 20e) and 50 (50a to 50e) each provided independently for a corresponding color among, for example, RGB (Red, Blue, and Green); and column AD converters 30 (31a to 31e and 32a to 32e) and 60 (61a to 61e and 62a to 62e) each provided independently for a corresponding color. The column AD converters 30 and 60 include: comparators 31 (31a to 31e) and 61 (61a to 61e) that compare signals; and counters 32 (32a to 32e) and 62 (62a to 62e) that count the clocks until a time point determined by a comparison by the comparators 31 and 61 between a pixel signal and a ramp signal. The solid-state imaging device 1 also includes ramp signal generating units 90a and 90b, horizontal scanning circuits 40 and 70, and a vertical scanning circuit 80.

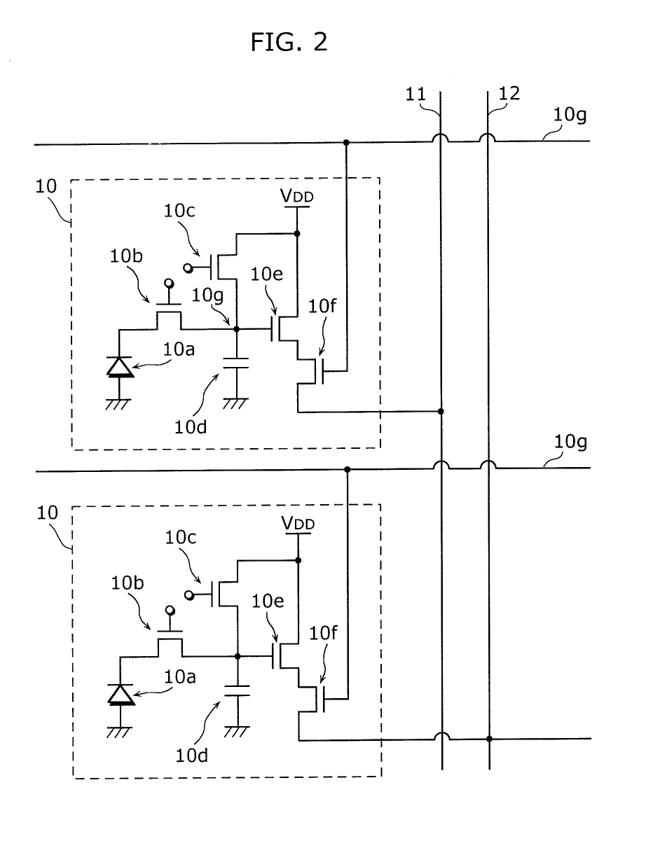

Each of the pixels 10 is a MOS image sensor or the like that converts light of one of RGB into an electric signal. They form an imaging surface (imaging unit) through arrangement in a matrix. As FIG. 2 shows, each pixel 10 includes the following: a photodiode (PD) 10a that performs photoelectric conversion on incident light to generate charge; a signal converting unit (floating diffusion: FD) 10d that accumulates the charge generated by the PD 10a and outputs the accumulated charge as a voltage signal; a reset Tr 10c that resets the voltage indicated by the FD 10d as an initial voltage (VDD in this case); a transfer Tr 10b that transfers the charge generated by the PD 10a to the FD 10d; an amplifying Tr 10e that generates a voltage that varies according to the voltage indicated by the FD 10d; a selecting Tr 10f that forwards the output of the amplifying Tr 10e to a column signal line 11 or 12 upon receiving a row selection signal from a row selection line 10g; a color filter; and so on. Each pixel 10 outputs to the column signal line 11 or 12 an electric signal corresponding to the intensity of light passing through the color filter. As FIG. 1 shows, color filters are arranged in the Bayer arrangement, for example. One red filter (R), two (first and second) green filters (Gr, Gb), and one blue filter (B) form one set, which, together with other sets, are arranged in a matrix.

Here, the connection between the pixels 10 and the column signal lines 11 is as follows: As FIG. 1 shows, for each column of the pixels 10 arranged in a matrix, two column signal lines, namely, the column signal lines 11 and 12, each corresponding to a color among RGB, are provided. In other words, each of the two column signal lines 11 and 12 is connected to all pixels 10 of the same color among the pixels 10 forming a column and assigned with two colors. For example, as FIG. 1 shows, in the first column which is the leftmost column, all pixels 10 for the first green (“Gr” in the diagram) forming the first column are connected to a column signal line 11, whereas all pixels 10 for blue (“B” in the diagram) forming the first column are connected to a column signal line 12. This is to allow the column amplifiers and column AD converters, which differ depending on the color, to amplify and process signals using a column amplifier gain and a column AD converter gain provided independently.

The column amplifiers 20 and 50 are variable gain amplifiers each selecting a gain from a plurality of gains based on an instruction from outside and amplifying output signals generated by corresponding pixels 10. Two column amplifiers, that is, one column amplifier 20 and one column amplifier 50, are provided for each column of the pixels 10 to correspond to each color of RGB.

On the surface of the semiconductor substrate on which the circuit is formed, the column amplifiers 20 are arranged on an area different from an area of the column amplifiers 50 (an area upper than the pixels and an area lower than the pixels). These areas sandwich the area of the pixels 10. That is to say, the column amplifiers 20 deposited on the area upper than the pixels 10 amplify signals outputted from the pixels 10 corresponding to a first group of colors (Gr and R) via the column signal lines 11, whereas the column amplifiers 50 deposited on the area lower than the pixels 10 amplify signals outputted from the pixels 10 corresponding to the other group of colors (B and Gb) via the column signal lines 12.

The solid-state imaging device 1 has control lines (gain control lines 1 to 4) each for instructing a column amplifying gain which is common to column amplifiers 20 and 50 which correspond to the same color, among the plural column amplifiers 20 and 50. More specifically, the gain control line 1 instructs a column amplifying gain which is common to the column amplifiers 20a, 20c, and 20e that amplify output signals generated by pixels 10 corresponding to all of the first greens (Gr); the gain control line 2 instructs a column amplifying gain which is common to the column amplifiers 20b and 20d that amplify output signals generated by pixels 10 corresponding to all of reds (R); the gain control line 3 instructs a column amplifying gain which is common to the column amplifiers 50a, 50c, and 50e that amplify output signals generated by pixels 10 corresponding to all of blues (B); and the gain control line 4 instructs a column amplifying gain which is common to the column amplifiers 50b and 50d that amplify output signals generated by pixels 10 corresponding to all of the second greens (Gb).

The ramp signal generating units 90a and 90b are reference signal generating units each generating, for AD conversion, a reference signal having a ramp waveform which temporally makes monotonic variations. They can vary the slope of the ramp waveform to change the column AD converter gains of the column AD converters 30 and 60 based on an instruction from outside (a control unit 100 mentioned later). For example, the ramp signal generating units 90a and 90b each generate a ramp signal by generating digital values that increment at a constant frequency, performing AD conversion on each of the digital values generated, and then by outputting an analog voltage generated by passing the converted digital values through a low pass filter. The ramp signal generating units 90a and 90b vary the slope of the ramp waveform by changing the frequency based on an instruction from outside.

It should be noted that although there are two ramp signal generating units 90a and 90b in the present embodiment, the solid-state imaging device according to the present invention may include one ramp signal generating unit. That is to say, a ramp signal from a single, common ramp signal generating unit may be inputted into all of the column AD converters 30 and 60. The structure may be determined in view of a trade-off between the circuit size and flexibility in controlling the column AD converter gains.

The column AD converters 30 are provided to correspond to the column amplifiers 20 which are arranged for corresponding colors of RGB, and the column AD converters 60 are provided to correspond to the column amplifiers 50 arranged for corresponding colors of RGB. Each of the column AD converters 30 and 60 is a circuit that performs AD conversion on signals generated by a corresponding one of the column amplifiers 20 and 50. The column AD converters 30 include: the comparators 31 (31a to 31e) each comparing a reference signal generated by the ramp signal generating unit 90a with an output signal generated by a corresponding column amplifier 20; and the counters 32 (32a to 32e) each counting clocks until a time point determined by the comparison by a corresponding comparator 31 between a pixel signal and the ramp waveform. Likewise, the column AD converters 60 include: the comparators 61 (61a to 61e) each comparing a reference signal generated by the ramp signal generating unit 90b with an output signal provided from a corresponding column amplifier 50; and the counters 32 (32a to 32e) each counting clocks until a time point determined by the comparison by a corresponding comparator 61 between a pixel signal and the ramp waveform. Here, a time period of counting clocks refers to a time from when the ramp waveform starts to be varied to when the comparator of the corresponding column shows a match between a pixel signal and the reference signal, for example.

The horizontal scanning circuits 40 are read control circuits that output a control signal to the counters 32 to cause sequential, horizontal scanning and outputting of digital values that are latched by the counters 32. Likewise, the horizontal scanning circuits 70 are read control circuits that output a control signal to the counters 62 to cause sequential, horizontal scanning and outputting of digital values that are latched by the counters 62. With this, the digital values latched by the counters 32 are outputted in sequence as digital output_A, in synchronization with the control signal from the horizontal scanning circuit 40, whereas the digital values latched by the counters 62 are outputted in sequence as digital output_B, in synchronization with the control signal from the horizontal scanning circuit 70.

The vertical scanning circuit 80 is a read control circuit that outputs a control signal (row selection signal) to each of the pixels 10 arranged in the matrix so that the signals generated by the pixels 10 are sequentially outputted to the column amplifiers 20 and 50 row by row in the vertical direction. In the present embodiment, the pixels 10 in every second row are connected to the same the column signal lines, either 11 or 12, and the pixels 10 in the other rows are connected to the other column signal lines 11 or 12. Thus, the vertical scanning may be performed in units of two rows (a method of selecting odd-numbered rows simultaneously and even-numbered rows simultaneously).

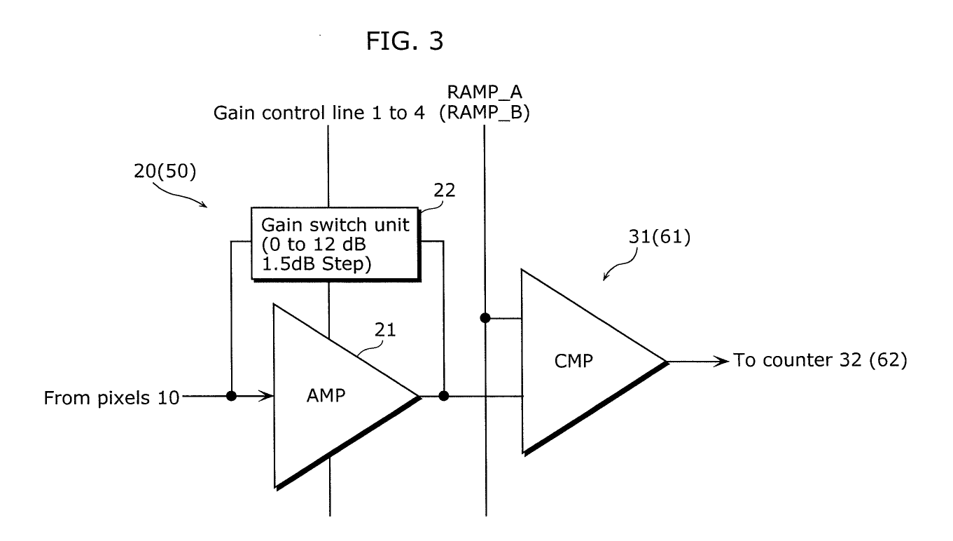

FIG. 3 is a circuit diagram of a set of a column amplifier 20 (50) and a column AD converter (here, only a comparator 31 (61) of the input stage is shown), excerpted from FIG. 1. As shown in the diagram, the solid-state imaging device 1 includes one column amplifier 20 (50) and one column AD converter (here, only a comparator 31 (61) of the input stage is shown) for each column of pixels 10 and for each color (R, Gr, Gb, B). The column amplifier 20 (50) includes an amplifier 21 and a gain switch unit 22. The gain switch unit 22 switches the gain of the column amplifier 20 within a range of, for example, 0 to 12 dB (1.5 dB step) in voltage amplification based on an instruction from the gain control line 1 (2 to 4). It should be noted that 12 dB corresponds to 2 bits (resolution) in AD conversion, and is a gain necessary for white balance and for optimizing the output signal generated by the column amplifier 20 (50) so that the voltage of the output signal comes close to the full scale of the input range of the column AD converter 30 (60).

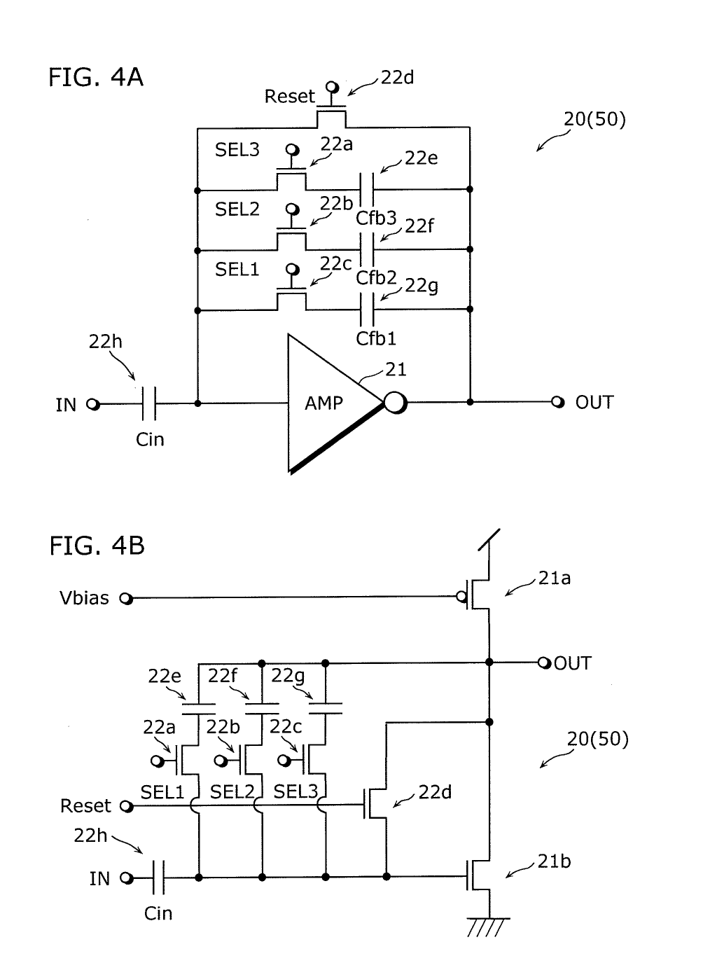

FIG. 4A is a detailed circuit block diagram of a column amplifier 20 (50). Shown here is a detailed circuit diagram of the gain switch unit 22 shown in FIG. 3. The gain switch unit 22 includes four transistors 22a to 22d that are turned on according to an instruction from the gain control line 1 (2 to 4) and four capacitors 22e to 22h that determine a gain. Each of three transistors 22a to 22c is a switch transistor connected to a corresponding one of the capacitors 22e to 22g as a feedback capacitor of the amplifier 21. Depending on the combination of turned-on transistors among the three transistors 22a to 22c (eight combinations), a total feedback capacitance Cfb of the amplifier 21 is determined. Thus, as shown in the expression below, the Gain of the column amplifier 20 (50) is a ratio between a capacitance Cin of the input capacitor 22h and the total feedback capacitance Cfb.

Gain=Cin/Cfb

In this manner, a gain is determined within a range of 0 to 12 dB (eight stages with a 1.5 dB step each), for example. The transistor 22d is a switch transistor for resetting the column amplifier 20 (50) by causing a short in the input and output terminal of the amplifier 21 before causing the amplifying operation of the column amplifier 20 (50), for example.

FIG. 4B shows a detailed circuit example of a column amplifier 20 (50) in the case where the amplifier 21 shown in FIG. 4A includes transistors. Shown here is an example where the amplifier 21 shown in FIG. 4A includes a pair of CMOS transistors (a PMOS transistor 21a and an NMOS transistor 21b). The NMOS transistor 21b is an amplifying transistor and the PMOS transistor 21a is a load (constant current source) thereof.

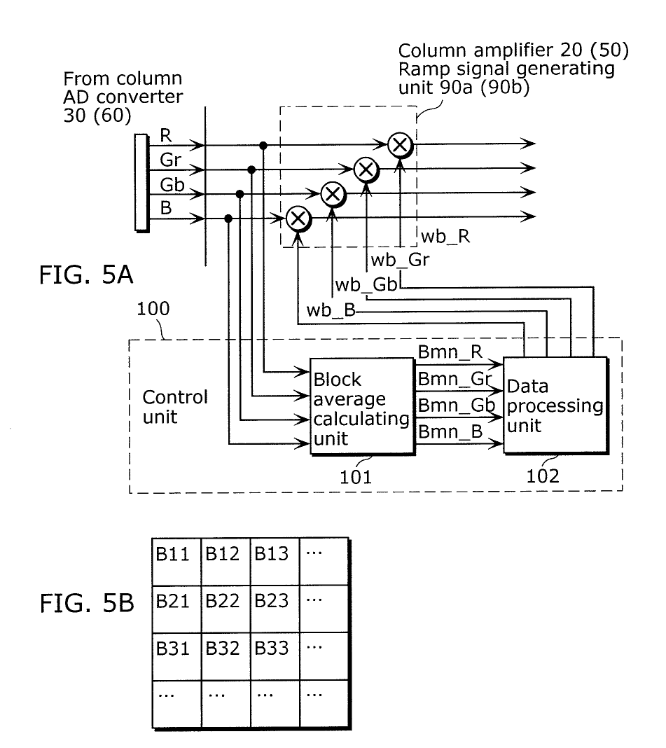

FIG. 5A is a circuit block diagram showing the structure of the control unit 100 included in the solid-state imaging device 1 according to the present embodiment. The control unit 100 is an internal control block or a DSP or the like that performs the following: controlling coarse adjustment for amplifying the output signals from the pixels 10 (column amplifying gain) by instructing a gain to the column amplifiers 20 and 50 for the purpose of gain adjustment for white balance; and controlling fine adjustment for amplifying the output signals from the pixels 10 (column AD converter gain) by instructing a slope of the ramp waveform to the ramp signal generating units 90a and 90b. The control unit 100 functionally includes a block average calculating unit 101 and a data processing unit 102.

The block average calculating unit 101 monitors digital values outputted from the counters 32 and 62 to calculate an average (Bmn_R, Bmn_Gr, Bmn_Gb, Bmn_B) of the digital values for each color (R, Gr, Gb, B) with respect to each block in the case where an imaging surface is divided into a plurality of areas (blocks) (see FIG. 5B).

Using the average calculated by the block average calculating unit 101 for each color, the data processing unit 102 calculates an R/G ratio and a B/G ratio and extracts a block that is closest to white based on the calculated R/G and B/G ratios. It then calculates a white balance coefficient Wb of the extracted block, and compares the calculated white balance coefficient Wb with a white balance coefficient Wb of the previous frame so as to determine whether or not to perform white balance control. When the white balance control is to be performed, the data processing unit 102 controls the gains through the coarse and fine adjustments as mentioned above (that is, it outputs gain instructions wb_R, wb_Gr, wb_Gb, wb_B to the column amplifiers 20 and 50 and the ramp signal generating units 90a and 90b via the gain control lines 1 to 4, for example). The detailed operation shall be described later with reference to a flowchart.

Next, the operation of the solid-state imaging device 1 according to the present embodiment structured as above shall be described.

First, before signals are read from the pixels 10, determined through an instruction from the control unit 100 are gains of the column amplifiers 20 and 50 and slopes of ramp waveforms of ramp signals generated by the ramp signal generating units 90a and 90b.

More specifically, an instruction from the gain control line 1 determines a gain of the column amplifiers 20a, 20c, and 20e that amplify output signals generated by the pixels 10 corresponding to all of the first greens (Gr); an instruction from the gain control line 2 determines a gain of the column amplifiers 20b and 20d that amplify output signals generated by the pixels 10 corresponding to all of reds (R); an instruction from the gain control line 3 determines a gain of the column amplifiers 50a, 50c, and 50e that amplify output signals generated by the pixels 10 corresponding to all of blues (B); and an instruction from the gain control line 4 determines a gain of the column amplifiers 50b and 50d that amplify output signals generated by the pixels 10 corresponding to all of the second greens (Gb).

Further, instructions given from the control unit 100 to the ramp signal generating units 90a and 90b via a control line (not shown) determine the slopes of the ramp waveforms of ramp signals generated by the ramp signal generating units 90a and 90b.

Then, when light is converted into electric signals by each pixel 10, the electric signals are read via the column signal lines 11 and 12 and inputted to the column amplifiers 20 and 50. For the reading of the electric signals, the control signal from the vertical scanning circuit 80 causes the signals generated by the pixels 10 arranged in the matrix to be sequentially outputted to the column amplifiers 20 and 50 row by row (or two rows at a time) from the top row to the bottom row (in the vertical direction), for example. Here, for the reading of the signals from the pixels 10 in each row, the signals from the pixels 10 corresponding to all of the first greens (Gr) are inputted to the column amplifiers 20a, 20c, and 20e; the signals from the pixels 10 corresponding to all of reds (R) are inputted to the column amplifiers 20b and 20d; the signals from the pixels 10 corresponding to all of blues (B) are inputted to the column amplifiers 50a, 50c, and 50e; and the signals from the pixels 10 corresponding to all of the second greens (Gb) are inputted to the column amplifiers 50b and 50d. In this manner, the signals read from the pixels 10 are inputted to the column amplifiers 20 and 50 dedicated to the columns in which the corresponding pixels are deposited.

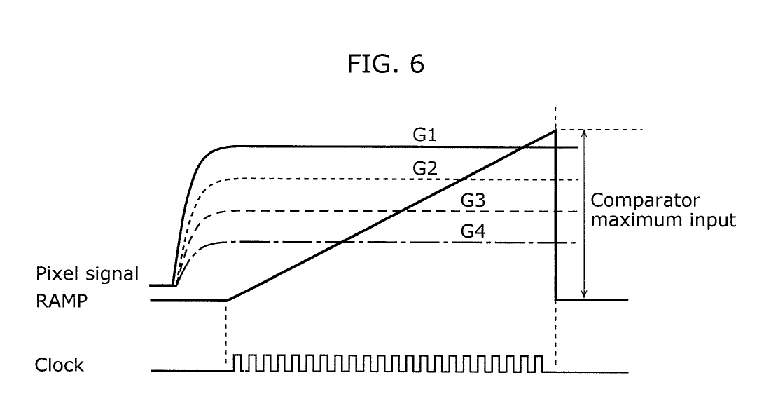

Next, the signals generated by the column amplifiers 20 and 50 are inputted to the column AD converters 30 and 60 each provided for a corresponding one of the column amplifiers 20 and 50, and undergo AD conversion as shown in FIG. 6. FIG. 6 shows a comparison between the pixel signals outputted from the column amplifiers 20 and 50 (shown here is an example of four types of voltages G1 to G4) and a ramp waveform (RAMP), and counting of the number of clocks therebetween (from the rising edge of the ramp waveform to the matches between the ramp waveform and each of the pixel signals).

To be more specific, when signals generated by the column amplifiers 20 and 50 are inputted to the comparators 31 and 61, the ramp signal generating units 90a and 90b each generate a ramp signal and the comparators 31 and 61 each compare the two signals (the output signal from a corresponding one of the column amplifiers and the ramp signal). In parallel with the comparison, the counters 32 and 62 each perform the following: start counting the clocks of a constant frequency (time measurement) when the ramp signal is generated; stop the counting when a corresponding one of the comparators 31 and 61 detects a match between the two input signals; and hold the counted value. By doing so, the counters 32 and 62 each hold digital values corresponding to the voltages of the output signals received from the corresponding column amplifier.

Then, the control signals from the horizontal scanning circuits 40 and 70 cause the digital values held by the counters 32 and 62 to be sequentially scanned and outputted as digital output_A and digital output_B.

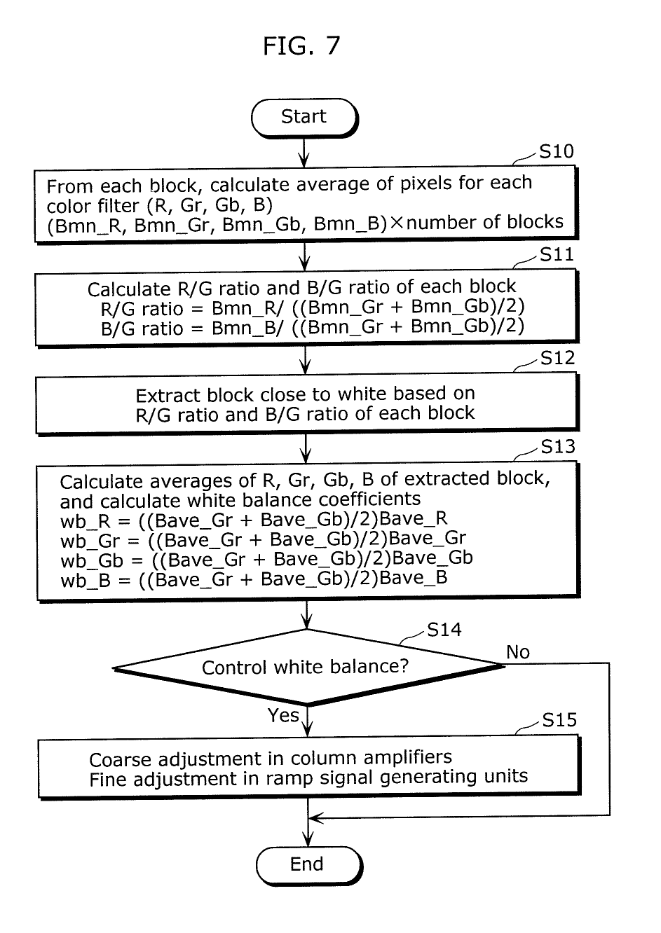

FIG. 7 is a flowchart showing a procedure of controlling the gain adjustment for white balance, performed by the control unit 100. Shown here is processing performed by the control unit 100 on a frame-by-frame basis.

First, the block average calculating unit 101 monitors digital values outputted from the counters 32 and 62 to calculate an average (Bmn_R, Bmn_Gr, Bmn_Gb, Bmn_B) of the digital values per color (R, Gr, Gb, B) for each block of the imaging surface (S10).

Next, using the average calculated per color by the block average calculating unit 101, the data processing unit 102 calculates an R/G ratio and a B/G ratio according to expressions shown in the diagram (S11), and extracts, based on the calculated R/G ratio and B/G ratio, a block that is closest to white (S12). For example, a block having an R/G ratio and a B/G ratio that are both close to 1 is extracted as the block closest to white.

Then, for the extracted block, the data processing unit 102 calculates a white balance coefficient for each color (wb_R, wb_Gr, wb_Gb, wb_B) according to expressions shown in the diagram, using the average (Bave_R, Bave_Gr, Bave_Gb, Bave_B) of the digital values of each color (R, Gr, Gb, B) (S13). Then, the data processing unit 102 compares the calculated white balance coefficient and a white balance coefficient of the previous frame so as to determine whether or not to control white balance (S14). For example, it determines to control the white balance only when there is at least one color for which a ratio between the white balance coefficient of the current frame and that of the previous frame exceeds 1.5 db.

Only when determining to control the white balance (Yes in S14), the data processing unit 102 controls coarse adjustment for amplifying the output signals of the pixels 10 by instructing a gain to the column amplifiers 20 and 50 corresponding to the colors that need the control, and controls fine adjustment for amplifying the output signals of the pixels 10 by instructing a slope of the ramp waveform to the ramp signal generating units 90a and 90b of the column AD converters 30 and 60 corresponding to the colors that need the control (S15). At this time, the coarse and fine adjustments are made so that the voltages of the output signals from the column amplifiers 20 and 50 come close to the full scale of the input range of the column AD converters 30 and 60. Here, since an abrupt change in the gain causes image distortions, when, for example, a gain-up by a coarse adjustment is made (e.g. +3 dB), the gain is changed in such a manner that only a minus gain corresponding to the gain-up is first set for the gain control of a fine adjustment, and the minus gain is gradually brought back to the positive side. By repeating such coarse and fine adjustments, the gain control is performed for the column amplifiers 20 and 50 and the column AD converters 30 and 60 corresponding to the colors that need the control.

In the present embodiment, the ramp signal generating unit 90a is provided for two colors and the ramp signal generating unit 90b is provided for the other two colors. Thus, the gains for the column AD converters 30 and 60 are not completely distinguished for each color. Therefore, the fine adjustment is, for example, to set an average of the gains for two colors corresponding to the column AD converters 30 or 60.

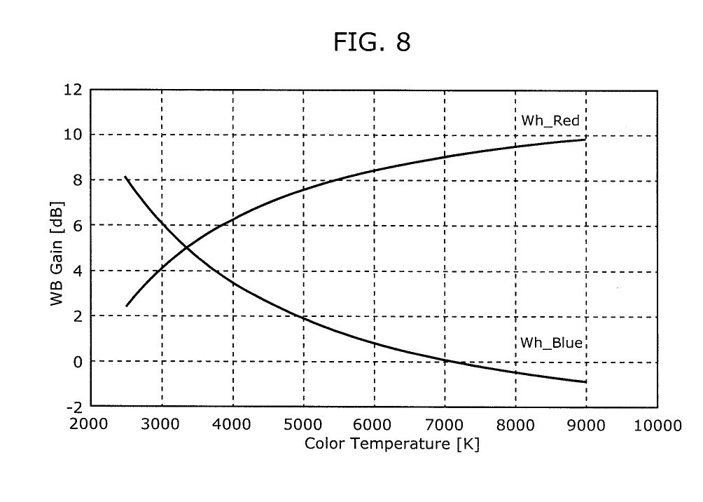

FIG. 8 shows a detailed illustration of gain setting made for the white balance suitable for color temperatures. In the diagram, the horizontal axis represents color temperature and the vertical axis represents the intensity (gain) of a red signal (Wh_Red) and a blue signal (Wh_Blue) when 0 dB is assumed for a green signal. As apparent from the diagram showing the difference between the gains on the curves of the two colors, a gain setting range of approximately 12 dB is sufficient for the white balance from lower color temperatures to higher color temperatures.

As above, according to the solid-state imaging device 1 of the present embodiment, the column amplifiers and the column AD converters are independently provided for each color, and by setting gains for the column amplifiers and the column AD converters, white balance adjustment is performed for each color independently. As a result, unlike the conventional art, the gains for each color are optimized without the need for complicated control of changing the resistance values of variable resistances and switching the switches depending on the pixels from which signals are to be read, while preventing an S/N deterioration in the AD conversion.

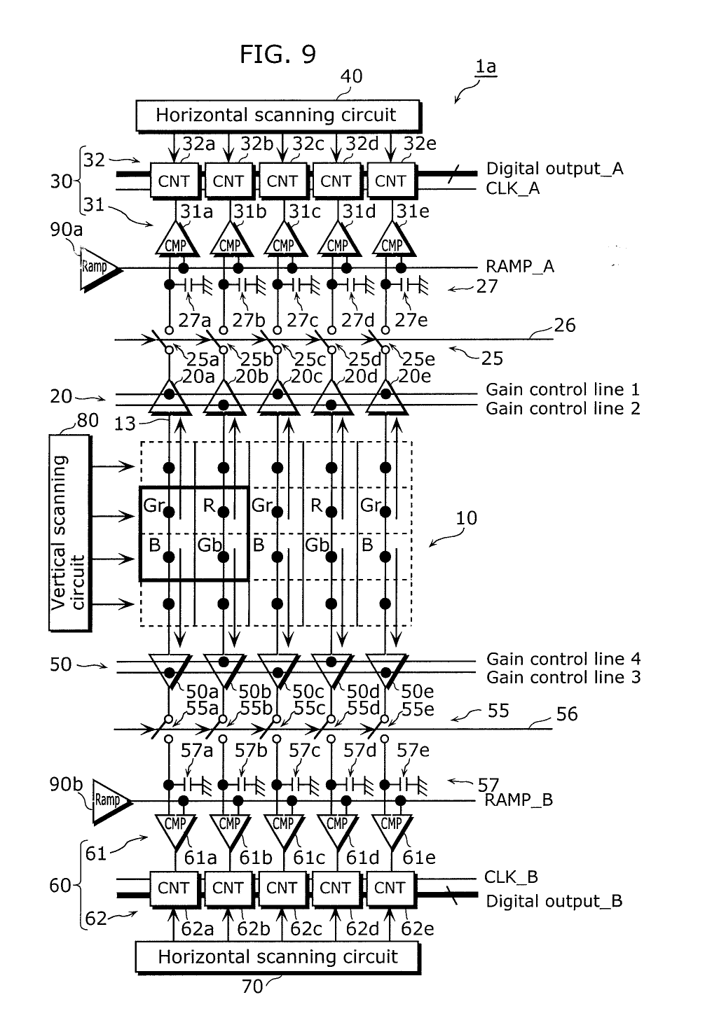

In the present embodiment, two column signal lines 11 and 12 are provided for each column of the pixels 10. However, the present invention is not limited to such arrangement of column signal lines. For example, as shown in FIG. 9, a column signal line 13 alone may be provided for each column of the pixels 10. With a solid-state imaging device 1a having such a structure, the output signals from the pixels 10 forming a column of the matrix are transferred, via the common column signal line 13, to input terminals of two column amplifiers 20 and 50 provided to correspond to the column. At the output sides of the column amplifiers 20 and 50, the solid-state imaging device 1a includes: row selection switches 25 (25a to 25e) and 55 (55a to 55e) for selecting signals of rows; signal holding capacitances 27 (27a to 27e) and 57 (57a to 57e) connected to the row selection switches and the comparators 31 and 61; and row selection control lines A (26) and B (56) that control the row selection switches 25 and 55, respectively. Among the pixels 10 forming a column of the matrix and corresponding to two colors, the pixels 10 corresponding to one of the colors output signals to the corresponding column amplifiers 20 via the column signal line 13, and the output signals are held by the signal holding capacitances 27, and the pixels 10 corresponding to the other color output signals to the corresponding column amplifiers 50 via the column signal line 13, and the output signals are held by the signal holding capacitances 57. This is performed through time division.

More specifically, in the first column which is the leftmost column, the output signals from the pixels 10 of the first green (“Gr” in the diagram) are processed by the column amplifiers 20 and the column AD converters 30, whereas the output signals from the pixels 10 of blue (“B” in the diagram) are processed by the column amplifiers 50 and the column AD converters 60.

With such wiring of the column signal lines as shown in FIG. 9, the operation of sending output signals from the pixels 10 of a row to the column amplifiers 20 and the operation of sending output signals from the pixels 10 of the next row to the column amplifiers 50 are alternately performed. The signals held by the signal holding capacitances 27 and 57 are processed in chronological order by the column AD converters 30 and 60, respectively.

### Embodiment 2

Next, Embodiment 2 of the present invention shall be described.

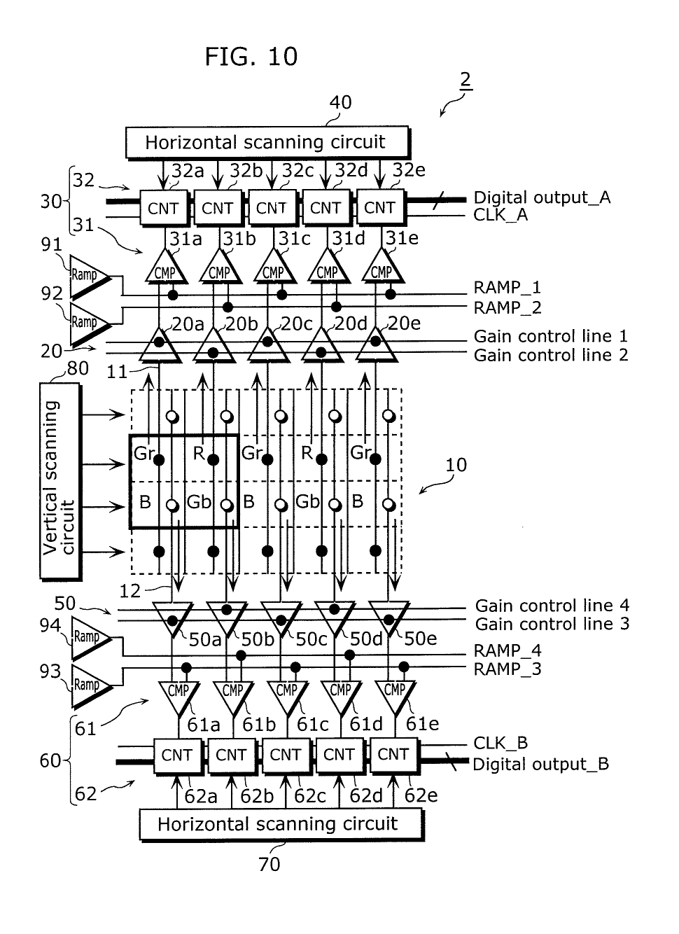

FIG. 10 is a circuit block diagram of a solid-state imaging device 2 according to Embodiment 2 of the present invention. The solid-state imaging device 2 is characterized in setting column AD converter gains which differ depending on the colors of RGB. It includes a plurality of pixels 10, a plurality of column amplifiers 20 and 50, a plurality of column AD converters 30 and 60, horizontal scanning circuits 40 and 70, a vertical scanning circuit 80, and ramp signal generating units 91 to 94.

The solid-state imaging device 2 is different from that of Embodiment 1 in that it includes four ramp signal generating unit 91 to 94 instead of two ramp signal generating units 90a and 90b in Embodiment 1. Other aspects are the same as Embodiment 1. Hereinafter, the same structural elements as those of Embodiment 1 are denoted with the same reference numerals, and the descriptions thereof shall be omitted.

The ramp signal generating units 91 to 94 are signal generating units which generate reference signals RAMP_1 to RAMP_4, respectively, having different ramp waveforms from each other for the AD conversion. Each of them can vary the slope of the ramp waveform so that the column AD converter gains of the column AD converters 30 and 60 can be changed based on an instruction from the control unit 100.

A characteristic point here is that each of the four ramp signal generating units 91 to 94 is provided for a corresponding one of the four colors (Gr, R, B, Gb). More specifically, the ramp signal generating unit 91 is a circuit that generates a ramp signal RAMP_1 for the comparators 31a, 31c, and 31e of the column AD converters 30a, 30c, and 30e corresponding to the pixels 10 of the first green (“Gr” in the diagram). The ramp signal generating unit 92 is a circuit that generates a ramp signal RAMP_2 for the comparators 31b and 31d of the column AD converters 30b and 30d corresponding to the pixels 10 of red (“R” in the diagram). The ramp signal generating unit 93 is a circuit that generates a ramp signal RAMP_3 for the comparators 61a, 61c, and 61e of the column AD converters 60a, 60c, and 60e corresponding to the pixels 10 of blue (“B” in the diagram) . The ramp signal generating unit 94 is a circuit that generates a ramp signal RAMP_4 for the comparators 61b and 61d of the column AD converters 60b and 60d corresponding to the pixels 10 of the second green (“Gb” in the diagram).

The operation of the solid-state imaging device 2 according to the present embodiment structured as above is basically the same as that of Embodiment 1. However, in Embodiment 1, the gains of the column amplifiers are set independently for each color and the gains of the column AD converters are set as a common gain between two colors, whereas in the present embodiment, the gains of the column amplifiers and the column AD converters are set independently for each of the four colors (Gr, R, B, Gb).

More specifically, the control unit 100 sets the gains of the column amplifiers and of the column AD converters (gains of coarse and fine adjustments) independently for each of the four colors (Gr, R, B, Gb) in the white balance adjustment (Step S15 in FIG. 7) in order to achieve the white balance coefficients obtained for each color in the preceding Step S14.

As above, according to the solid-state imaging device 2 of the present embodiment, the column amplifiers and the column AD converters are independently provided for each color, and by setting gains of the column amplifiers and the column AD converters for each color, white balance adjustment is performed for each color independently. As a result, unlike the conventional art, the gains for each color are optimized without the need for complicated control of changing the resistance values of variable resistances and switching the switches depending on the pixels from which signals are to be read, while preventing an S/N deterioration in the AD conversion.

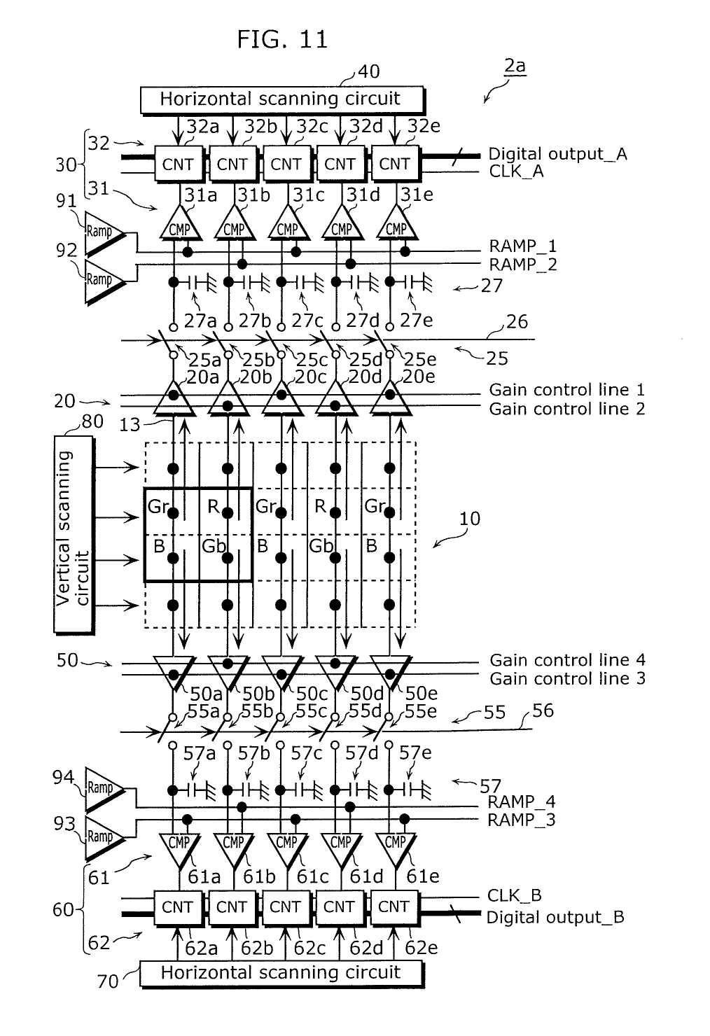

In the present embodiment also, as described in Embodiment 1, the number of column signal lines provided for each column of the pixels 10 may be one or two. More precisely, in the present embodiment, two column signal lines 11 and 12 are provided for each column of the pixels 10, but as shown in FIG. 11, there may be a column signal line 13 alone for each column of the pixels 10. With a solid-state imaging device 2a having such a structure, the output signals from the pixels 10 forming a column of the matrix are transferred, via the common column signal line 13, to input terminals of two column amplifiers 20 and 50 provided to correspond to the column. At the output sides of the column amplifiers 20 and 50, the solid-state imaging device 2a includes: row selection switches 25 (25a to 25e) and 55 (55a to 55e) for selecting signals of rows; signal holding capacitances 27 (27a to 27e) and 57 (57a to 57e) connected to the row selection switches and the comparators 31 and 61; and row selection control lines A (26) and B (56) that control the row selection switches 25 and 55, respectively. Among the pixels 10 forming a column of the matrix and corresponding to two colors, the pixels 10 corresponding to one of the colors output signals to the corresponding column amplifiers 20 via the column signal line 13, and the pixels 10 corresponding to the other color output signals to the corresponding column amplifiers 50 via the column signal line 13. This is performed through time division.

Thus far, the solid-state imaging device according to the present invention has been described based on Embodiments 1 and 2 and the variations thereof 1a and 2a. However, the present invention is not limited to these embodiments and variations. The present invention is intended to include other embodiments to be achieved by those skilled in the art by modifying the above embodiments and variations, and also other embodiments to be achieved by freely combining the structural elements of the above embodiments and variations.

For example, Embodiments 1 and 2 and the variations thereof 1a and 2a assume the Bayer arrangement of RGB, but other various arrangements apart from the Bayer arrangement are known as color filter arrangement, such as the complementary color filter, the Green stripe filter, and the clear-vid filter. Obviously, such color filter arrangements are also possible to correspond to each color in the same structure as that of the embodiments and variations of the present invention.

Further, Embodiments 1 and 2 and the variations thereof 1a and 2a describe that for each of the colors (R, B, Gr, Gb), corresponding column amplifiers and column AD converters are provided, and that the gains are adjusted separately. However, common column amplifiers and common column AD converters may be provided for the pixels of similar colors, such as Gr and Gb, so as to adjust the gains together. The structure may be determined in view of a trade-off between circuit size and flexibility in gain control, for example.

Furthermore, Embodiments 1 and 2 and the variations thereof 1a and 2a show the example where the column amplifiers and the column AD converters are provided on an area upper than the pixels and on an area lower than the pixels, so as to sandwich the area on which the pixels are formed. However, obviously, it is also possible to provide the column amplifiers and the column AD converters on one side of the pixel area at a double-density of each column or in multiple layers, such as two layers, for example.

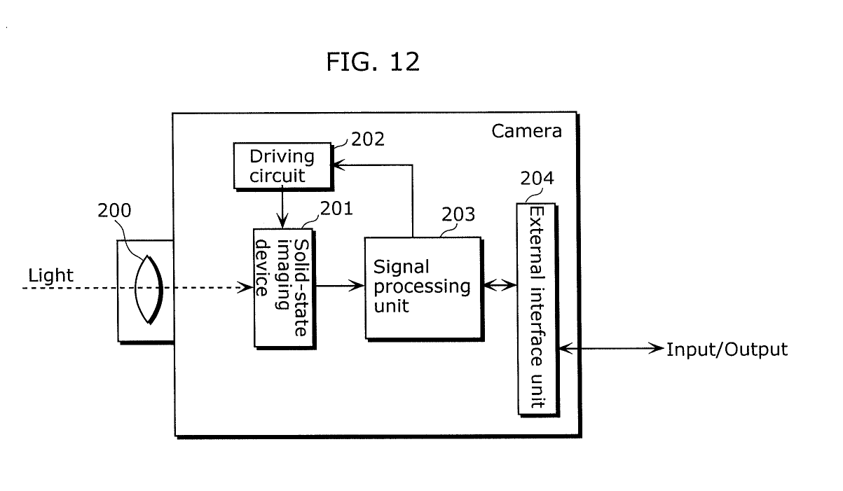

It should be also apparent that various electric appliances equipped with the solid-state imaging device of the present invention are included in the present invention. For example, as shown in a functional block diagram of FIG. 12, a camera equipped with a solid-state imaging device 201 according to the present invention (the imaging surface, the column amplifiers, the column AD converters and so on of the solid-state imaging device according to the above embodiments and variations) is included in the present invention. As FIG. 12 shows, the camera includes a lens 200, the solid-state imaging device 201, a driving circuit 202 (the horizontal scanning circuits, the vertical circuit and the like of the above embodiments), a signal processing unit 203 (the control unit and the like of the above embodiments), and an external interface unit 204.

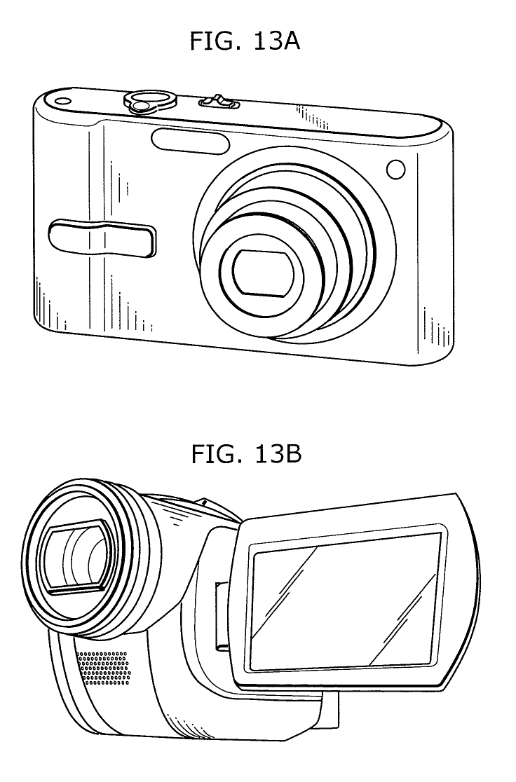

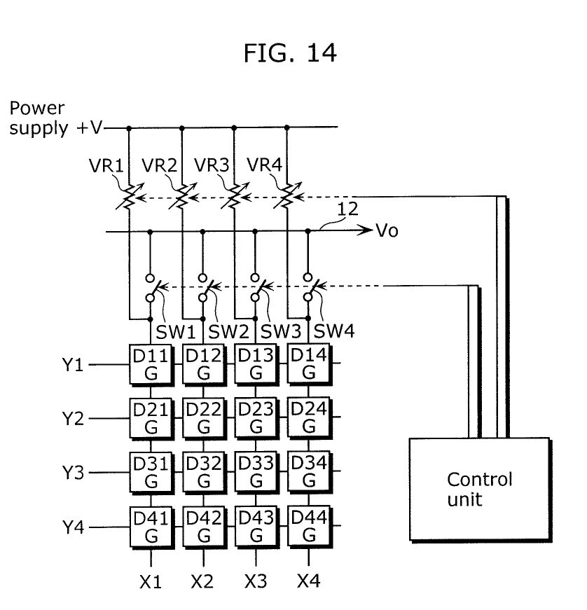

With the camera of such a structure, light passing through the lens 200 enters the solid-state imaging device 201. The signal processing unit 203 drives the solid-state imaging device 201 via the driving circuit 202, and reads output signals from the solid-state imaging device 201. The output signals undergo various signal processing by the signal processing unit 203 and the resultant is outputted outside via the external interface unit 204. Such a camera includes a solid-state imaging device which optimizes the gains for each color without the need for complicated control of changing the resistance values of variable resistances and switching the switches depending on the pixels from which signals are to be read, while preventing an S/N deterioration in the AD conversion. Thus, appropriate white balance adjustment is performed to suit the color temperatures of the object without decreasing the processing rate and deteriorating the S/N ratio. Such a camera is achieved as a digital still camera shown in FIG. 13A and a video camera shown in FIG. 13B, for example.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention can be applied to a solid-state imaging device such as a color image sensor. For example, it can be applied to an imaging device of a digital still camera, a video camera, and a mobile phone equipped with a digital camera.

What is claimed is:

1. A solid-state imaging device comprising:
a plurality of pixels arranged in a matrix;
column amplifiers, each amplifying signals generated by pixels of a corresponding one of columns of the matrix; and
column AD converters, each performing AD conversion on a signal generated by a corresponding one of said column amplifiers, wherein each of said plurality of pixels generates a signal corresponding to intensity of incident light of a color among colors, and
each of said column amplifiers amplifies output signals generated by all pixels of a corresponding one of the colors, among pixels of the corresponding column of the matrix.

2. The solid-state imaging device according to claim 1,
wherein said plurality of pixels is arranged such that pixels corresponding to at least two colors are included in at least one column,
said column amplifiers are arranged such that at least two column amplifiers correspond to each column of the matrix,
one of said at least two column amplifiers amplifies output signals generated by pixels corresponding to a first color, among the pixels of the corresponding column which correspond to the at least two colors, and
another one of said at least two column amplifiers amplifies output signals generated by pixels corresponding to a second color, among the pixels of the corresponding column which correspond to the at least two colors, the second color being different from the first color.

3. The solid-state imaging device according to claim 2,
wherein output signals generated by pixels of a column of the matrix are transferred to input terminals of said at least two column amplifiers corresponding to the column, via a corresponding one of at least two column signal lines corresponding to at least one column,
among pixels of a column of the matrix which correspond to the at least two colors, pixels corresponding to a first color output signals to a corresponding one of said at least two column amplifiers via first one of the at least two column signal lines, and
among the pixels of the column of the matrix which correspond to the at least two colors, pixels corresponding to a second color output signals to a corresponding one of said at least two column amplifiers via second one of the at least two column signal lines.

4. The solid-state imaging device according to claim 2,
wherein output signals generated by pixels of a column of the matrix are transferred to input terminals of said at least two column amplifiers corresponding to the column, via a common column signal line,
among pixels of a column of the matrix which correspond to the at least two colors, pixels corresponding to a first color output signals to a corresponding one of said at least two column amplifiers via the common column signal line, and pixels corresponding to a second color output signals to a corresponding one of said at least two column amplifiers via the common column signal line, by time division.

5. The solid-state imaging device according to claim 2,
wherein said solid-state imaging device is formed on a semiconductor substrate, and
said column amplifiers are arranged on different areas that sandwich an area on which said plurality of pixels is formed, the areas being on a surface of the semiconductor substrate, on which a circuit is formed.

6. The solid-state imaging device according to claim 1,
wherein each of said column amplifiers selects a gain from a plurality of gains based on an instruction from outside, and amplifies the signals using the selected gain.

7. The solid-state imaging device according to claim 6, further comprising
control lines, each for instructing a common gain to corresponding ones of said column amplifiers, the corresponding ones of said column amplifiers corresponding to a same color among the colors.

8. The solid-state imaging device according to claim 6, further comprising
a reference signal generating unit configured to generate a reference signal having a ramp waveform that temporally makes monotonic variations,
wherein each of said column AD converters includes:
a comparator corresponding to a column of the matrix for comparing each of pixel signals generated by pixels of the corresponding column with the reference signal generated by said reference signal generating unit; and
a counter unit configured to count clocks applied from when said reference signal generating unit starts varying the reference signal to when said comparator of the corresponding column shows a match between a pixel signal and the reference signal,
wherein said reference signal generating unit is configured to vary a slope of the ramp waveform of the reference signal to be generated, based on an instruction from outside.

9. The solid-state imaging device according to claim 8, comprising
reference signal generating units, each configured to generate a reference signal having a ramp waveform which corresponds to one of the colors,
wherein said comparator compares the reference signal with a pixel signal corresponding to the one of the colors, and
said solid-state imaging device further comprises a control unit configured to instruct a slope of the ramp waveform to each of said reference signal generating units.

10. The solid-state imaging device according to claim 9,
wherein said control unit is configured to control coarse adjustment for amplifying output signals generated by said plurality of pixels, by instructing a gain to said column amplifiers, and to control fine adjustment for amplifying the output signals generated by said plurality of pixels, by instructing a slope of the ramp waveform to said reference signal generating units.

11. A camera comprising the solid-state imaging device according to claim 1.

12. A method for driving a solid-state imaging device, said method comprising,
in the solid-state imaging device according to claim 8,
controlling coarse adjustment for amplifying output signals generated by the plurality of pixels, by instructing a gain to the column amplifiers, and controlling fine adjustment for amplifying the output signals generated by the plurality of pixels, by instructing a slope of the ramp waveform to the reference signal generating units.
